(19) United States
(12) Patent Application Publication
(10) Pub. No.: US 2002/0184001 A1
(43) Pub. Date: Dec. 5, 2002

(54) System for integrating an emulator and a processor

(75) Inventor: Steven Yao, Taipei (TW)

Correspondence Address: BACON & THOMAS, PLLC, 625 SLATERS LANE, FOURTH FLOOR, ALEXANDRIA, VA, 22314

(73) Assignee: Glovic Electronic Co., Taipei (TW)

(21) Appl. No.: 10/079,552

(22) Filed: Feb. 22, 2002

(30) Foreign Application Priority Data
May 29, 2001 (TW) 90112869

(51) Int. Cl. G06F 9/455

(52) U.S. Cl. 703/28

(57) ABSTRACT

A system for integrating an emulator and a processor, the system comprises a device for integrating the emulator and the processor, the emulator emulating the processor; an ICE universal controller connecting to the device for communicating with the emulator and obtaining an emulation result from the emulator; a computer connecting to the ICE universal controller for observing the emulation result and controlling the ICE universal controller.

### FIELD OF THE INVENTION

The present invention is related to a system for integrating an emulator and a processor, and more particularly to an system having the processor embedded the emulator for a computer to monitor emulation results by a serial transmission method.

### BACKGROUND OF THE INVENTION

An ICE (In-Circuit Emulator) is used to emulate instructions and processes of each kind of processor. That is an important stage for developing a digital circuit system. The development of a digital circuit system needs verification very often. During the verification, the ICE can monitor the system status by the method of step by step or setting break points. If errors are found, a debug process could be prosecuted for succeeding the development of the digital circuit system.

FIG. 1 shows a conventional ICE system. One side of the ICE 12 connects to a computer 13. The computer 13 monitors the emulation results or commands the ICE to do some jobs by a relative software 14. Another side of the ICE 12 connects to a circuit system 11 to be verified. The ICE 12 includes a main unit 121, a cable 122, trace probes 123 and a remote control unit 124. The ICE 12 emulates the CPUs (Central Process Unit), i.e. 8051/52, 8031/32, 8751/52, etc. The system to be verified is designed for a CPU so the ICE may emulate the CPU to control and monitor the system when the verification process is executed. During the verification, the ICE can obtain the status of the system such as the contents of the memory, the registers, the flags, etc. Therefore, any error in the system can be observed and debugged, so as to make sure that the system is valid as linking to a true CPU.

The conventional ICE has following disadvantages:

1. The utility is only issued on the development stage. An IC (Integrated Circuit) system embedded a CPU must put on the market for selling. If the system should be failed, people could not confirm the problem is come form the system itself or the CPU.

2. Each kind of CPU has a different ICE target. That is not convenient for the ICE operations.

### SUMMARY OF THE INVENTION

An object of the present invention is to integrate a CPU and an ICE target into an integrated circuit (IC) system for simplifying the operation steps on emulation.

Another object of the present invention is to on-line diagnose the system faults comes from the system itself or the embedded CPU.

According to the present invention, a device for integrating an emulator and a processor, the device comprises: a circuit body embedding a system circuit, the processor and the emulator, the emulator electrically connecting to the processor for emulating the processor and verifying the circuit system electrically connecting to the processor, the emulator being disable when the circuit system is verified.

In accordance with one aspect of the present invention, the circuit body is an application specific integrated circuit.

In accordance with one aspect of the present invention, the processor is a CPU.

In accordance with one aspect of the present invention, the emulator is an ICE target.

In accordance with one aspect of the present invention, the ICE target comprises: a multiplexer for switching between a system data bus and an emulation data bus; an ICE circuit for forming the emulation data bus, connecting to a system signal bus and the system data bus, and emulating and detecting the processor to verify the circuit system; and a serial to parallel command decoder having two sides, the one side serially outputting an emulation result of the ICE circuit and serially inputting a command, the another side outputting the command to the ICE circuit in parallel.

In accordance with one aspect of the present invention, the device integrating the emulator and the processor is connected to an ICE universal controller.

In accordance with one aspect of the present invention, the ICE universal controller comprises a serial to parallel command decoder, a controller main circuit, a computer interface and a trace buffer.

According to the present invention, a method for integrating an emulator and a processor, the method comprises steps of: embedding the emulator into a circuit body having the processor and a circuit system; and emulating the processor with an ICE universal controller electrically connected to the emulator embedded in the circuit body.

In accordance with one aspect of the present invention, the circuit body is an application specific integrated circuit.

In accordance with one aspect of the present invention, the processor is a CPU.

In accordance with one aspect of the present invention, the emulator is an ICE target.

In accordance with one aspect of the present invention, the ICE target comprises: a multiplexer for switching between a system data bus and an emulation data bus; an ICE circuit for forming the emulation data bus, connecting to a system signal bus and the system data bus, and emulating and detecting the processor to verify the circuit system; and a serial to parallel command decoder having two sides, the one side serially outputting an emulation result of the ICE circuit and serially inputting a command, the another side outputting the command to the ICE circuit in parallel.

In accordance with one aspect of the present invention, the ICE universal controller comprises a serial to parallel command decoder, a controller main circuit, a computer interface and a trace buffer.

According to the present invention, a system for integrating an emulator and a processor, the system comprises: a device for integrating the emulator and the processor, the emulator emulating the processor; an ICE universal controller connecting to the device for communicating with the emulator and obtaining an emulation result from the emulator; a computer connecting to the ICE universal controller for observing the emulation result and controlling the ICE universal controller.

In accordance with one aspect of the present invention, the device is embedded into a circuit body.

In accordance with one aspect of the present invention, the circuit is an application specific integrated circuit.

In accordance with one aspect of the present invention, the processor is a CPU.

In accordance with one aspect of the present invention, the emulator is an ICE target.

In accordance with one aspect of the present invention, the ICE universal controller comprises a serial to parallel command decoder, a controller main circuit, a computer interface and a trace buffer.

The present invention may best be understood through the following description with reference to the accompanying drawings, in which:

### BRIEF DESCRIPTION OF THE DRAWINGS

FIG. 1 is a conventional ICE system architecture;

FIG. 2 is an integrated ICE system architecture according to the present invention; and

FIG. 3 is an ICE block diagram in detail according to the present invention.

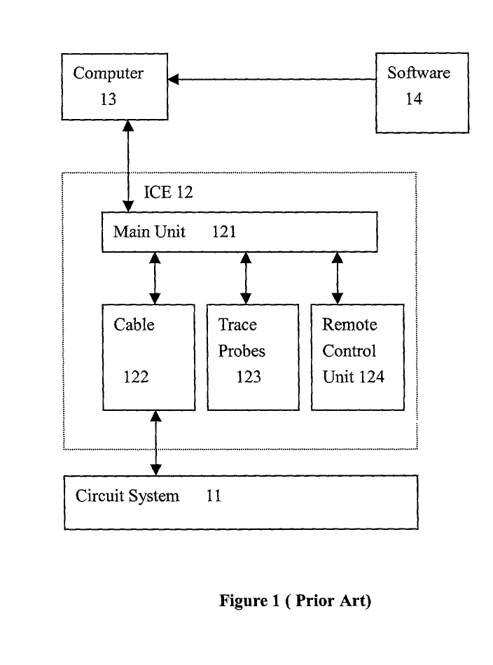

### DETAILED DESCRIPTION OF THE PREFERRED EMBODIMENT

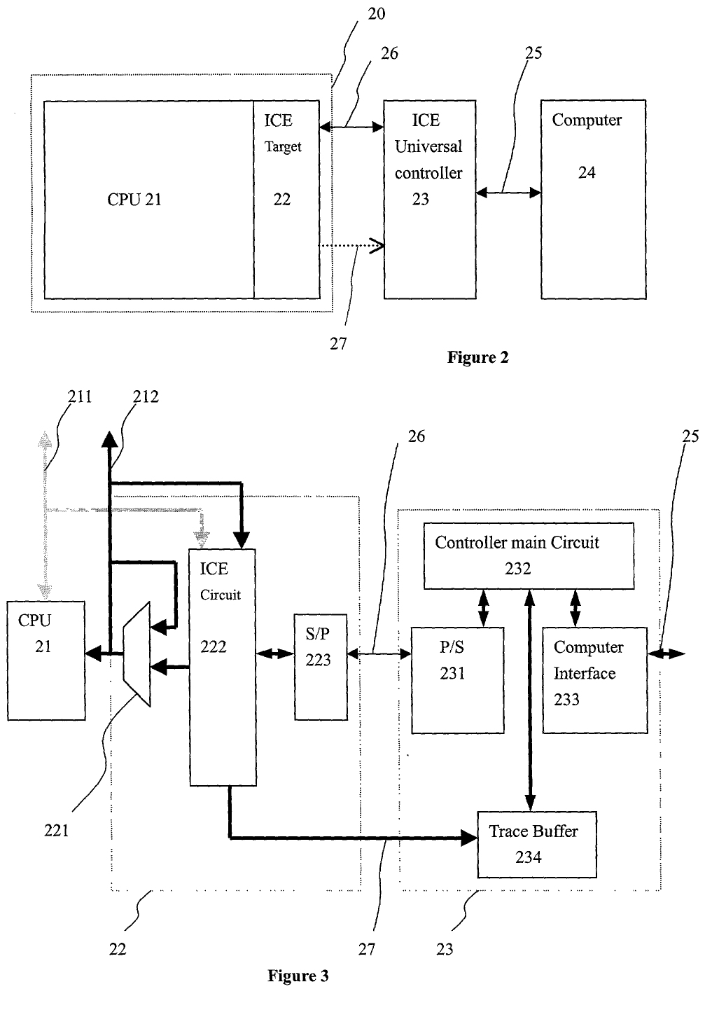

Please refer to FIG. 2 showing the ICE system architecture according to the present invention. The device for integrating the emulator and the processor is made as an ASIC 20 (Application Specific Integrated Circuit) embedding an ICE target 22 and a CPU 21. During the verification stage, the emulation process can be run by switching to the ICE target, and in case of normal operations the CPU can be selected to control the circuit system 201 (maybe outside the ASIC). Due to the progress of semiconductor process, it is none sensuous to embed an ICE target into a CPU, however it is quit obvious that the benefit in the verification and maintenance will be promoted.

On the development stage, the developer can directly connect ASIC 20 to the ICE universal controller 23. There are no problem to setup a different ICE target dependent on a different CPU. Therefore, the procedure of operation will be simplified. The system developer only needs to operate the software on the computer 24 so that the emulation results can be easily observed and the commands can be directly executed by an interface port 25. After the system is developed completely, some problems will appear on the yield stage, for example the fault with the semiconductor process. In this case, the ICE target embedded in the ASIC can be used to emulate on-line for checking the problem comes from the CPU or the circuit system. Therefore, the problem can be resolved through the emulation earlier than usual. After the ASIC system is sold, the embedded ICE target can used to check the system operation status and to debug the system in case of need.

The ICE target is embedded into the CPU, while it needs very few gate counts. The cost of CPU may be raised very little, while the profits in the system debug, verification and maintenance are very large. The ICE universal controller 23 is responsible for the bridge between the ICE target and the computer, but it is fixed to each CPU. Therefore, the development of ICE system has the advantages of speedup and cost down, while the operation of the ICE system will be easier than usual.

The embedded ICE target has two reserved pins 26 used for the functions selection. This two reserved pins 26 can execute most of ICE functions, but the function of trace buffer download needs some extra pins 27. The number of extra pins 27 may be 4, 8, 16, 32, etc. If the write signal is added, then the number of extra pins 27 will be 5, 9, 17, 33, etc. These extra pins 27 are used for receiving trace data.

Please refer to FIG. 3 showing the ICE block diagram in detail. The ICE target comprises an ICE circuit 222, multiplexer 221 and serial to parallel command decoder 223 (S/P). Their functions are described as follows:

(1) The ICE circuit has the general functions of an ICE but without the trace buffer. At least, the ICE circuit can execute the ICE functions including break, halt, go, single step, register read/write, memory read/write and up/down load program, etc. If executing the trace function, the trace buffer 234 in the ICE universal controller 23 is needed.

(2) The multiplexer 221 (MUX) is used for changing the CPU signal paths. The bidirectional in/out data bus 212 of the CPU 21 is modified. The input data bus is provided by MUX 221. The MUX 221 can select the original CPU input data bus or the ICE circuit 222 input data bus. The selection function of the two input data bus is provided by the ICE circuit 222. The output data bus of the CPU 21 is fixed for the CPU 21 to output data directly. Secondly, the control signal 211 of the CPU 21 is dependent on conditions. Some signal paths need to modified on specific conditions, for example the upload/download is executed, while some signal paths need not to modified, but all the CPU signal path connected to the outside need enter into ICE target 22.

(3) The serial to parallel command decoder 223 (S/P) has the function of transferring the serial command format into the parallel command format, decoding and executing the command. Additionally, it may send the data (from parallel to serial) to the ICE universal controller 23.

The ICE universal controller 23 at least includes a parallel to serial command decoder 231 (P/S), a controller main circuit 232, a computer interface 233 and trace buffer 234. Their functions are described as follows:

(1) The computer interface 233 may be one kind or more. The computer interface 233 may be RS232, parallel port, USB, a specific transfer port, etc. It may send the computer data to the controller main circuit 232 or send the data of the controller main circuit 232 to the computer.

(2) The controller main circuit 232 includes the functions of how to execute the command from the computer, how to transfer the ICE target data to the computer, how to report the ICE target status to computer, how to send the trace buffer data, etc.

(3) The parallel to serial command decoder 231 (P/S) transfers the commands or operations of the controller main circuit 232 to the serial format data and sends the serial format data to the ICE target. Additionally, the parallel to serial command decoder 231 also transfers the serial data of the ICE target to the parallel format data, and sends the parallel format data to the controller main circuit 232.

(4) The trace buffer 234 stores the trace data sent from the ICE target, and depending on the request of the computer, sends the trace data to the computer by ways of the controller main circuit 232 and the computer interface 233.

The present invention embeds the ICE target into the CPU. The circuit body of ASIC may include the ICE target, the CPU and the circuit system. The advantages of the present invention is as follows:

1. The emulation of the CPU and the development of digital circuit system are convenient since the ICE target is embedded into the CPU.

2. The ICE target at least needs two reserved pins to execute most of ICE functions. Regarding to the trace data function, some extra pins may expanded depending on the requirement of the ICE system.

3. The operation of the ICE system may be easier than usual since the ICE universal controller is fixed and the setup procedure is simplified.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A device for integrating an emulator and a processor, said device comprising:
a circuit body embedding a system circuit, said processor and said emulator, said emulator electrically connecting to said processor for emulating said processor and verifying said circuit system electrically connecting to said processor, said emulator being disable when said circuit system is verified.

2. A device according to claim 1 wherein said circuit body is an application specific integrated circuit.

3. A device according to claim 1 wherein said processor is a CPU.

4. A device according to claim 1 wherein said emulator is an ICE target.

5. A device according to claim 4 wherein said ICE target comprises:
a multiplexer for switching between a system data bus and an emulation data bus;
an ICE circuit for forming said emulation data bus, connecting to a system signal bus and said system data bus, and emulating and detecting said processor to verify said circuit system; and
a serial to parallel command decoder having two sides, said one side serially outputting an emulation result of said ICE circuit and serially inputting a command, said another side outputting said command to said ICE circuit in parallel.

6. A device according to claim 1 wherein said device integrating said emulator and said processor is connected to an ICE universal controller.

7. A device according to claim 6 wherein said ICE universal controller comprises a serial to parallel command decoder, a controller main circuit, a computer interface and a trace buffer.

8. A method for integrating an emulator and a processor, said method comprising steps of:
embedding said emulator into a circuit body having said processor and a circuit system; and
emulating said processor with an ICE universal controller electrically connected to said emulator embedded in said circuit body.

9. A method according to claim 8 wherein said circuit body is an application specific integrated circuit.

10. A method according to claim 8 wherein said processor is a CPU.

11. A method according to claim 8 wherein said emulator is an ICE target.

12. A method according to claim 11 wherein said ICE target comprises:
a multiplexer for switching between a system data bus and an emulation data bus;
an ICE circuit for forming said emulation data bus, connecting to a system signal bus and said system data bus, and emulating and detecting said processor to verify said circuit system; and
a serial to parallel command decoder having two sides, said one side serially outputting an emulation result of said ICE circuit and serially inputting a command, said another side outputting said command to said ICE circuit in parallel.

13. A method according to claim 8 wherein said ICE universal controller comprises a serial to parallel command decoder, a controller main circuit, a computer interface and a trace buffer.

14. A system for integrating an emulator and a processor, said system comprising:
a device for integrating said emulator and said processor, said emulator emulating said processor;
an ICE universal controller connecting to said device for communicating with said emulator and obtaining an emulation result from said emulator;
a computer connecting to said ICE universal controller for observing said emulation result and controlling said ICE universal controller.

15. A system according to claim 14 wherein said device is embedded into a circuit body.

16. A system according to claim 15 wherein said circuit is an application specific integrated circuit.

17. A system according to claim 14 wherein said processor is a CPU.

18. A system according to claim 14 wherein said emulator is an ICE target.

19. A system according to claim 14 wherein said ICE universal controller comprises a serial to parallel command decoder, a controller main circuit, a computer interface and a trace buffer.
